(19) United States
(12) Patent Application Publication
(10) Pub. No.: US 2018/0325049 A1
(43) Pub. Date: Nov. 15, 2018

(54) Lawn Irrigation System

(71) Applicant: Giulio Baldassarra, Nobleton (CA)

(72) Inventor: Giulio Baldassarra, Nobleton (CA)

(21) Appl. No.: 15/590,117

(22) Filed: May 9, 2017

(51) Int. Cl. A01G 25/16; A01G 25/00; B05B 15/10; G05B 15/02

(52) U.S. Cl. CPC A01G 25/16; G05B 15/02; B05B 15/10; A01G 25/00

(57) ABSTRACT

A lawn irrigation system includes an electronic device that is selectively manipulated. A plurality of sprinkler units is provided and each of the sprinkler units is positioned in ground. Each of the sprinkler units is fluidly coupled to a water source. Each of the sprinkler units is selectively positioned in a deployed position to spray a fluid onto ground for irrigation. Additionally, each of the sprinkler units is positioned in a stored position. A control unit is in electrical communication with each of the sprinkler units. The control unit is in electrical communication with the electronic device such that the electronic device wirelessly controls operational parameters of the plurality of sprinkler units. The control unit selectively turns on selected ones of the sprinkler units to irrigate a selected area of the ground.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to irrigation devices and more particularly pertains to a new irrigation device for irrigating selected areas of a yard.

### BRIEF SUMMARY OF THE INVENTION

An embodiment of the disclosure meets the needs presented above by generally comprising an electronic device that is selectively manipulated. A plurality of sprinkler units is provided and each of the sprinkler units is positioned in ground. Each of the sprinkler units is fluidly coupled to a water source. Each of the sprinkler units is selectively positioned in a deployed position to spray a fluid onto ground for irrigation. Additionally, each of the sprinkler units is positioned in a stored position. A control unit is in electrical communication with each of the sprinkler units. The control unit is in electrical communication with the electronic device such that the electronic device wirelessly controls operational parameters of the plurality of sprinkler units. The control unit selectively turns on selected ones of the sprinkler units to irrigate a selected area of the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a sprinkler unit of a lawn irrigation system according to an embodiment of the disclosure being shown in deployed position.

FIG. 2 is a top perspective view of a sprinkler unit of an embodiment of the disclosure being shown in a stored position.

FIG. 3 is a bottom view of sprinkler unit of an embodiment of the disclosure.

FIG. 4 is a top view of sprinkler unit of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

FIG. 7 is a schematic view of an embodiment of the disclosure.

### DETAILED DESCRIPTION OF THE INVENTION

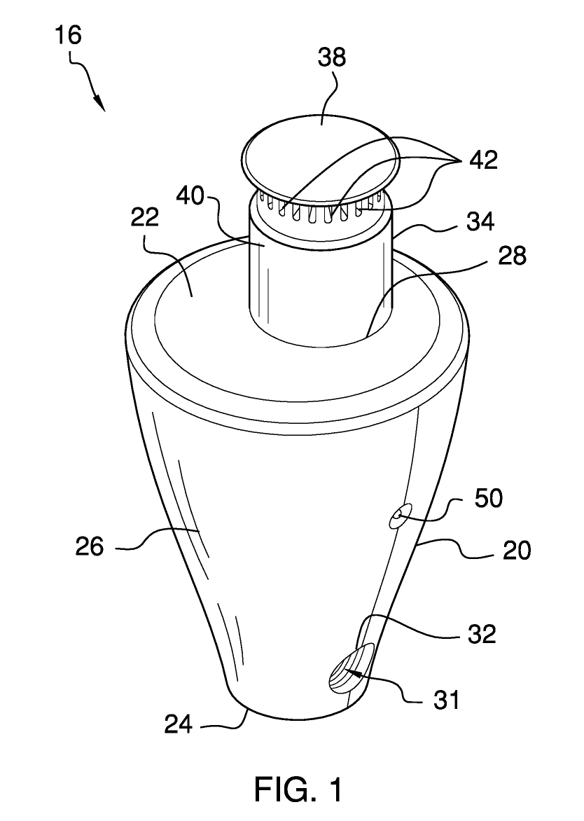

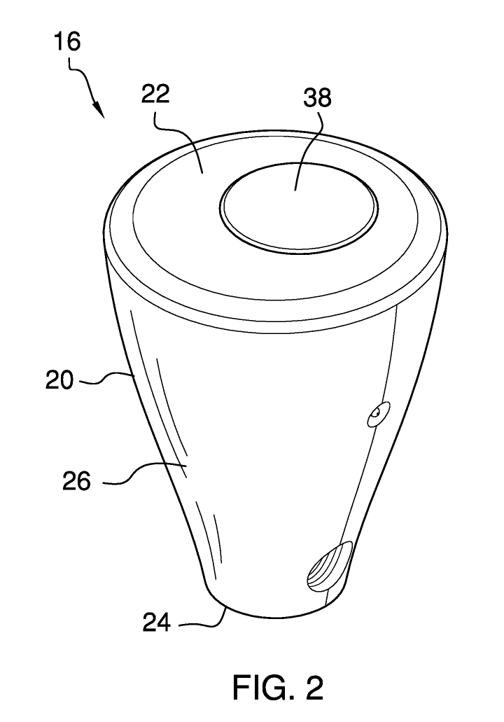

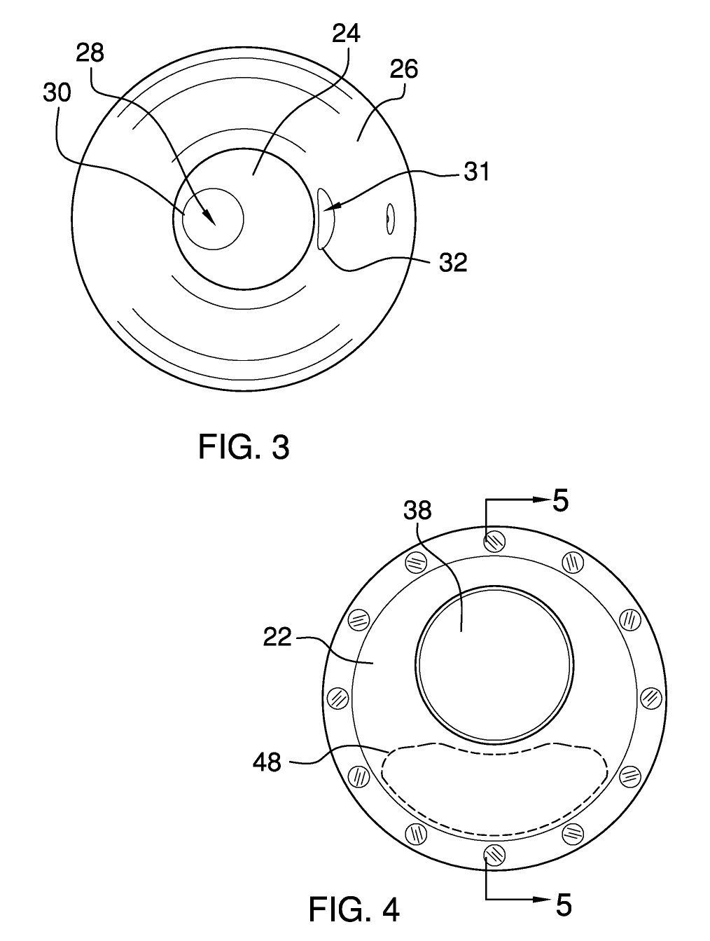

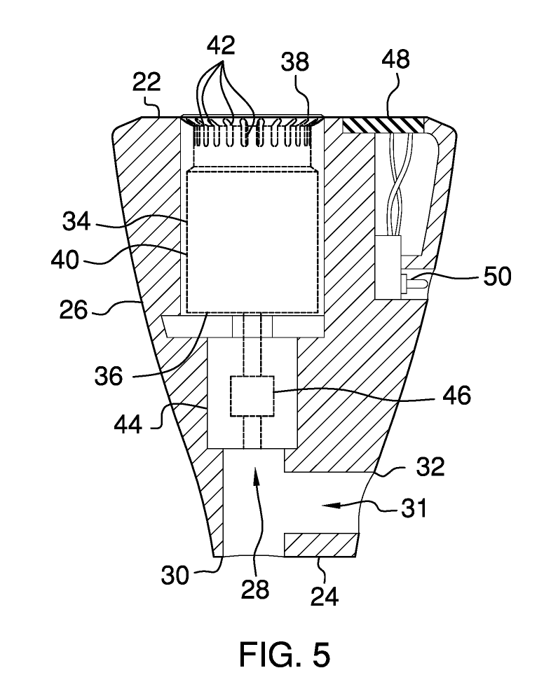

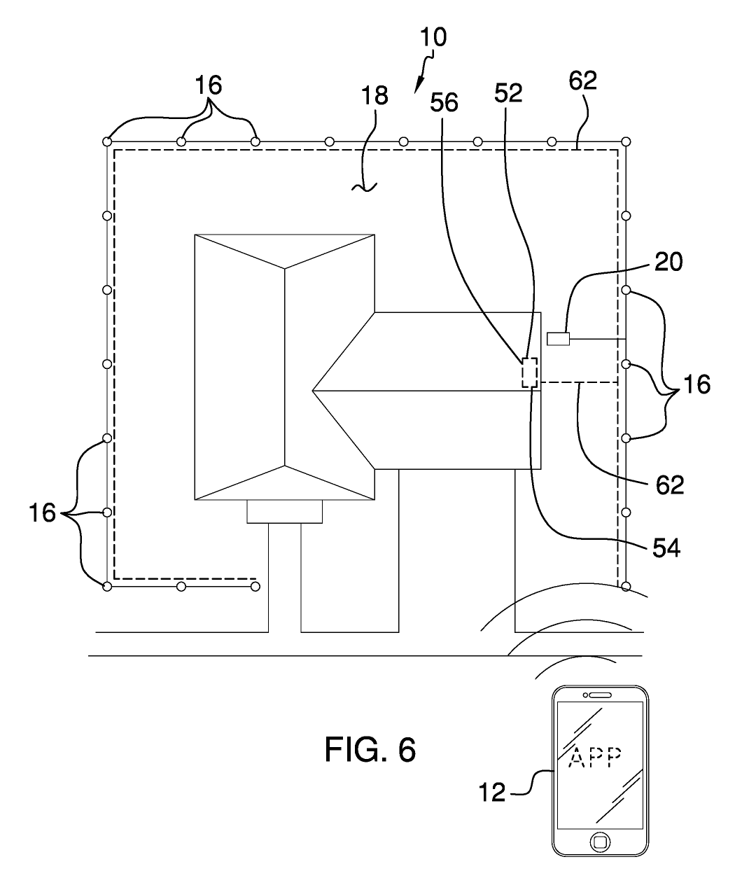

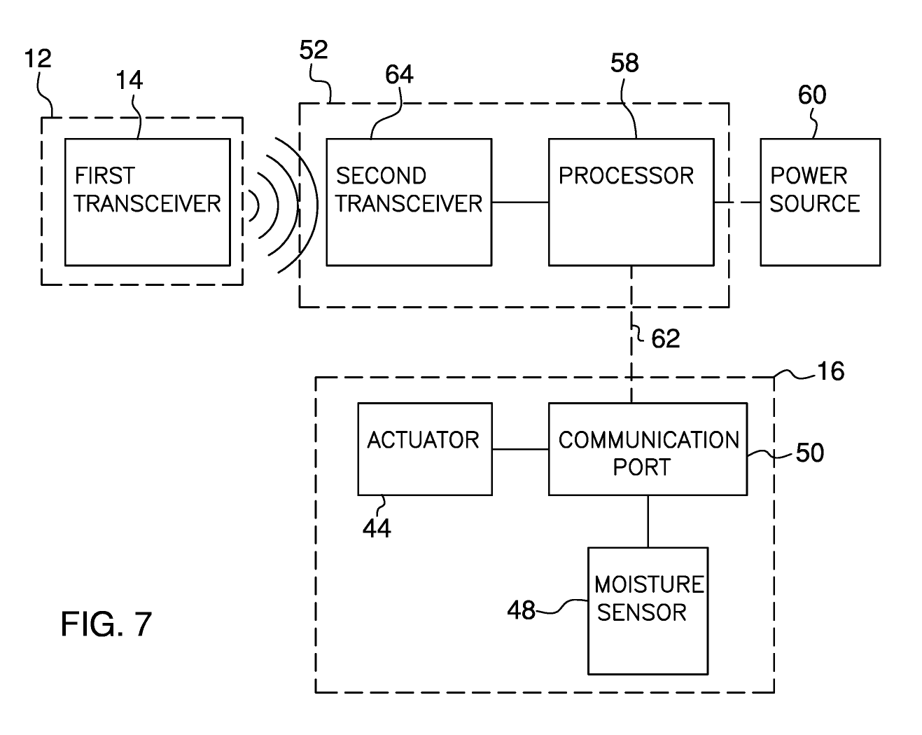

With reference now to the drawings, and in particular to FIGS. 1 through 7 thereof, a new irrigation device embodying the principles and concepts of an embodiment of the disclosure and generally designated by the reference numeral 10 will be described.

As best illustrated in FIGS. 1 through 7, the lawn irrigation system 10 generally comprises an electronic device 12 that is selectively manipulated. The electronic device 12 has a first transceiver 14 and the electronic device 12 stores data pertaining to a control program. The electronic device 12 may be a smartphone, an I-pad, a computer or any other electronic device 12 that has digital storage capabilities. The first transceiver 14 may be a radio frequency transceiver or the like and the first transceiver 14 may employ a WPAN signal and Bluetooth communication protocols.

A plurality of sprinkler units 16 is provided and each of the sprinkler units 16 is positioned in ground 18. Each of the sprinkler units 16 is fluidly coupled to a water source 20 such as a water line or the like. Moreover, each of the sprinkler units 16 may be distributed around a perimeter of a yard to irrigate the yard. Additionally, each of the sprinkler units 16 may be arranged around a plurality of areas, such as a garden or flower bed, to irrigate each of the areas.

Each of the sprinkler units 16 is selectively positioned in a deployed position to spray water onto ground 18 for irrigation. Each of the sprinkler units 16 is in wireless electrical communication with the electronic device 12. In this way the electronic device 12 is manipulated to actuate selected ones of the sprinkler units 16 for customized irrigation. Thus, the yard may be selectively irrigated and each of the areas may be selectively irrigated. Each of the sprinkler units 16 is positioned in a stored position.

Each of the sprinkler units 16 comprises a first housing 20 that has a top wall 22, a bottom wall 24 and a perimeter wall 26 extending therebetween. The perimeter wall 26 is continuous and the bottom wall 24 has a diameter is less than a diameter of the top wall 22 such that the first housing 20 forms a frustum. The first housing 20 has an aperture 28 extending through the top wall 22 and the bottom wall 24 to define a first port 30 on the bottom wall 24. The first housing 20 is positioned in the ground 18 having the top wall 22 being aligned with a surface of the ground 18. The perimeter wall 26 has a well 31 extending into the aperture 28 to define a second port 32 on the perimeter wall 26.

A selected one of the first 30 and second 32 ports is fluidly coupled to the water source 20. In this way the first housing 20 may be fluidly coupled to a pre-existing water distribution line that has vertical or horizontal water supply ports. Thus, the plurality of sprinkler units 16 may be retro-fitted onto an existing irrigation system. Additionally, the water source 20 may be a newly installed water distribution line that has vertical or horizontal water supply ports. The first 30 and second 32 ports on the first housing 20 facilitate the sprinkler units 16 to be incorporated into any pre-existing or newly installed water distribution line.

Each of the sprinkler units 16 includes a sprinkler head 34 that has a lower end 36, an upper end 38 and an outer wall 40 extending therebetween. The outer wall 40 is continuous such that the sprinkler head 34 has a cylindrical shape and the sprinkler head 34 is substantially hollow. The sprinkler head 34 is slidably positioned in the aperture 28. The lower end 36 is in fluid communication with each of the first 30 and second 32 ports to receive water from the water source 20. The outer wall 40 has a plurality of slots 42 extending into an interior of the sprinkler head 34 to selectively spray the fluid outwardly therefrom. Each of the slots 42 is aligned with the upper end 38 and the slots 42 are spaced apart from each other and are distributed around the outer wall 40.

An actuator 44 is positioned in the aperture 28 and the actuator 44 is positioned beneath the sprinkler head 34. The actuator 44 is coupled to the lower end 36 of the sprinkler head 34. The actuator 44 is turned on to selectively urge the sprinkler head 34 upwardly in the aperture 28. Thus, the upper end 38 of the sprinkler head 34 is spaced from the top wall 22 of the first housing 20 such that each of the slots 42 is exposed. The actuator 44 is turned off to selectively urge the sprinkler head 34 downwardly in the aperture 28 having the upper end 38 of the sprinkler head 34 being aligned with the top wall 22 of the first housing 20. The actuator 44 may be an electrically controlled solenoid or other mechanical actuator 44.

A valve 46 is coupled to the actuator 44 and the valve 46 is fluidly coupled between the sprinkler head 34 and each of the first 30 and second 32 ports. The valve 46 is positioned in a closed position when the actuator 44 urges the sprinkler head 34 downwardly. Thus, the valve 46 inhibits the water from flowing to the sprinkler head 34. The valve 46 is positioned in an open position when the actuator 44 urges the sprinkler head 34 upwardly. In this way the valve 46 allows the fluid to flow to the sprinkler head 34. The valve 46 may be a mechanical fluid valve of any conventional design and the valve 46 may be in mechanical communication with the actuator 44 through any conventional mechanical means.

A moisture sensor 48 is coupled to the top wall 22 of the first housing 20. The moisture sensor 48 senses atmospheric humidity in an area proximate the first housing 20. The moisture sensor 48 may be an electronic moisture sensor or the like. A communication port 50 is coupled to the outer wall 40 of the first housing 20 and the communication port 50 is electrically coupled to the moisture sensor 48. The communication port 50 may comprise a low voltage connection port such as a 12.0 volt connection port and a 24.0 volt connection port.

A control unit 52 is provided and the control unit 52 is in electrical communication with each of the sprinkler units 16. The control unit 52 is in electrical communication with the electronic device 12 such that the electronic device 12 wirelessly controls operational parameters of the plurality of sprinkler units 16. The control unit 52 selectively turns on selected ones of the sprinkler units 16 to irrigate a selected portion of the yard and a selected area. The control unit 52 comprises a second housing 54 that is coupled to a support surface 56. The support surface 56 may be a wall of a building, an electrical panel or any other support surface 56 that is located in proximity to the yard.

A processor 58 is positioned within the second housing 54 and the processor 58 is electrically coupled to a power source 60. The power source 60 may be an electrical system of a building, a female electrical outlet or any other source of electrical power. A conductor 62 is buried underground 18 and the conductor 62 is electrically coupled to the processor 58. The conductor 62 is electrically coupled to the communication port 50 corresponding to each of the sprinkler units 16. In this way the processor 58 controls the actuator 44 corresponding to each of the sprinkler units 16. Additionally, the actuator 44 corresponding to each of the sprinkler units 16 may be assigned a unique identification with respect to each other. In this way the processor 58 is able to differentiate between each of the sprinkler units 16.

A second transceiver 64 is positioned within the second housing 54 and the second transceiver 64 is electrically coupled to the processor 58. The second transceiver 64 is in electrical communication with the first transceiver 14 such that the second transceiver 64 receives commands from the electronic device 12. The second transceiver 64 may comprise a radio frequency transceiver or the like. Additionally, the second transceiver 64 may employ a WPAN signal and Bluetooth communication protocols.

The processor 58 turns the actuator 44 on corresponding to the selected sprinkler units 16 in accordance with the commands received from the electronic device 12. Moreover, the processor 58 turns the actuator 44 off corresponding to the selected sprinkler unit in accordance with the commands received from the electronic device 12. The second transceiver 64 communicates to the electronic device 12 the atmospheric humidity received from the moisture sensor 48 corresponding to each of the sprinkler units 16.

In use, the program on the electronic device 12 is employed to view the atmospheric humidity reported from the moisture sensor 48 corresponding to each of the sprinkler units 16. The electronic device 12 is manipulated to turn on selected ones of the sprinkler units 16 to irrigate areas that have low atmospheric humidity. In this way selected portions of the yard and the selected areas are irrigated in a customized fashion. Additionally, selected ones of the sprinkler units 16 are turned on at pre-determined times in accordance with a schedule that is determined with the program on the electronic device 12. Each of the plurality of sprinkler units 16 are turned on and off in any selected sequence, combination and schedule. Thus, the sprinkler units 16 facilitate customized irrigation thereby enhancing water conservation efforts and enhancing irrigation efficiency.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lawn irrigation system comprising:
an electronic device being configured to be manipulated;
a plurality of sprinkler units, each of said sprinkler units being configured to be positioned in ground, each of said sprinkler units being configured to be fluidly coupled to a water source, each of said sprinkler units being selectively positioned in a deployed position wherein each of said sprinkler units is configured to spray a fluid onto ground for irrigation, each of said sprinkler units being positioned in a stored position; and
a control unit being in electrical communication with each of said sprinkler units, said control unit being in electrical communication with said electronic device such that said electronic device wirelessly controls operational parameters of said plurality of sprinkler units, said control unit selectively turning on selected ones of said sprinkler units wherein each of said selected sprinkler units is configured to irrigate a selected area of the ground.

2. The system according to claim 1, wherein each of said sprinkler units comprises a first housing having a top wall, a bottom wall and a perimeter wall extending therebetween, said perimeter wall being continuous, said bottom wall having a diameter being less than a diameter of said top wall such that said first housing forms a frustum.

3. The system according to claim 2, wherein said first housing has an aperture extending through said top wall and said bottom wall to define a first port on said bottom wall, said first housing being configured to be positioned in the ground having said top wall being aligned with a surface of the ground.

4. The system according to claim 3, wherein said perimeter wall has a well extending into said aperture to define a second port on said perimeter wall, a selected one of said first and second ports being configured to be fluidly coupled to the water source.

5. The system according to claim 4, further comprising a sprinkler head having a lower end, an upper end and an outer wall extending therebetween, said outer wall being continuous such that said sprinkler head has a cylindrical shape, said sprinkler head being substantially hollow, said sprinkler head being slidably positioned in said aperture, said lower end being in fluid communication with each of said first and second ports wherein said sprinkler head is configured to receive the fluid.

6. The system according to claim 5, wherein said outer wall has a plurality of slots extending into an interior of said sprinkler head wherein each of said slots is configured to selectively spray the fluid outwardly therefrom, each of said slots being aligned with said upper end, said slots being spaced apart from each other and being distributed around said outer wall.

7. The system according to claim 5, further comprising an actuator being positioned in said aperture, said actuator being positioned beneath said sprinkler head, said actuator being coupled to said lower end of said sprinkler head, said actuator being turned on to selectively urge said sprinkler head upwardly in said aperture having said upper end of said sprinkler head being spaced from said top wall of said first housing such that each of said slots is exposed, said actuator being turned off to selectively urge said sprinkler head downwardly in said aperture having said upper end of said sprinkler head being aligned with said top wall of said first housing.

8. The system according to claim 7, further comprising a valve being coupled to said actuator, said valve being fluidly coupled between said sprinkler head and each of said first and second ports, said valve being positioned in a closed position when said actuator urges said sprinkler head downwardly wherein said valve is configured to inhibit the fluid from flowing to said sprinkler head, said valve being positioned in an open position when said actuator urges said sprinkler head upwardly wherein said valve is configured to allow the fluid to flow to said sprinkler head.

9. The system according to claim 2, further comprising a moisture sensor being coupled to said top end of said first housing wherein said moisture sensor is configured to sense atmospheric humidity in an area proximate said first housing.

10. The system according to claim 9, further comprising a communication port being coupled to said outer wall of said first housing, said communication port being electrically coupled to said moisture sensor.

11. The system according to claim 1, wherein said control unit comprises a second housing being configured to be coupled to a support surface.

12. The system according to claim 11, further comprising a processor being positioned within said second housing, said processor being configured to be electrically coupled to a power source.

13. The system according to claim 12, further comprising:
each of said sprinkler units including a communication port and an actuator; and
a conductor being configured to be buried underground, said conductor being electrically coupled to said processor, said conductor being electrically coupled to said communication port corresponding to each of said sprinkler units such that said processor controls said actuator corresponding to each of said sprinkler units.

14. The system according to claim 13, further comprising:
said electronic device having a first transceiver, said electronic device storing data pertaining to a control program; and
a second transceiver being positioned within said second housing, said second transceiver being electrically coupled to said processor, said second transceiver being in electrical communication with said first transceiver such that said second transceiver receives commands from said electronic device, said processor turning said actuator on corresponding to said selected sprinkler units in accordance with said commands received from said electronic device, said processor turning said actuator off corresponding to said selected sprinkler unit in accordance with said commands received from said electronic device, said second transceiver communicating to said electronic device the relative humidity received from said moisture sensor corresponding to each of said sprinkler units.

15. A lawn irrigation system comprising:
an electronic device being configured to be manipulated, said electronic device have a first transceiver, said electronic device storing data pertaining to a control program;
a plurality of sprinkler units, each of said sprinkler units being configured to be positioned in ground, each of said sprinkler units being configured to be fluidly coupled to a water source, each of said sprinkler units being selectively positioned in a deployed position wherein each of said sprinkler units is configured to spray a fluid onto ground for irrigation, each of said sprinkler units being positioned in a stored position, each of said sprinkler units comprising:
a first housing having a top wall, a bottom wall and a perimeter wall extending therebetween, said perimeter wall being continuous, said bottom wall having a diameter being less than a diameter of said top wall such that said first housing forms a frustum, said first housing having an aperture extending through said top wall and said bottom wall to define a first port on said bottom wall, said first housing being configured to be positioned in the ground having said top wall being aligned with a surface of the ground, said perimeter wall having a well extending into said aperture to define a second port on said perimeter wall, a selected one of said first and second ports being configured to be fluidly coupled to the water source,
a sprinkler head having a lower end, an upper end and an outer wall extending therebetween, said outer wall being continuous such that said sprinkler head has a cylindrical shape, said sprinkler head being substantially hollow, said sprinkler head being slidably positioned in said aperture, said lower end being in fluid communication with each of said first and second ports wherein said sprinkler head is configured to receive the fluid, said outer wall having a plurality of slots extending into an interior of said sprinkler head wherein each of said slots is configured to selectively spray the fluid outwardly therefrom, each of said slots being aligned with said upper end, said slots being spaced apart from each other and being distributed around said outer wall,
an actuator being positioned in said aperture, said actuator being positioned beneath said sprinkler head, said actuator being coupled to said lower end of said sprinkler head, said actuator being turned on to selectively urge said sprinkler head upwardly in said aperture having said upper end of said sprinkler head being spaced from said top wall of said first housing such that each of said slots is exposed, said actuator being turned off to selectively urge said sprinkler head downwardly in said aperture having said upper end of said sprinkler head being aligned with said top wall of said first housing,
a valve being coupled to said actuator, said valve being fluidly coupled between said sprinkler head and each of said first and second ports, said valve being positioned in a closed position when said actuator urges said sprinkler head downwardly wherein said valve is configured to inhibit the fluid from flowing to said sprinkler head, said valve being positioned in an open position when said actuator urges said sprinkler head upwardly wherein said valve is configured to allow the fluid to flow to said sprinkler head,
a moisture sensor being coupled to said top wall of said first housing wherein said moisture sensor is configured to sense atmospheric humidity in an area proximate said first housing, and
a communication port being coupled to said outer wall of said first housing, said communication port being electrically coupled to said moisture sensor;
a control unit being in electrical communication with each of said sprinkler units, said control unit being in electrical communication with said electronic device such that said electronic device wirelessly controls operational parameters of said plurality of sprinkler units, said control unit selectively turning on selected ones of said sprinkler units wherein each of said selected sprinkler units is configured to irrigate a selected area of the ground, said control unit comprising:
a second housing being configured to be coupled to a support surface,
a processor being positioned within said second housing, said processor being configured to be electrically coupled to a power source,
a conductor being configured to be buried underground, said conductor being electrically coupled to said processor, said conductor being electrically coupled to said communication port corresponding to each of said sprinkler units such that said processor controls said actuator corresponding to each of said sprinkler units, and
a second transceiver being positioned within said second housing, said second transceiver being electrically coupled to said processor, said second transceiver being in electrical communication with said first transceiver such that said second transceiver receives commands from said electronic device, said processor turning said actuator on corresponding to said selected sprinkler units in accordance with said commands received from said electronic device, said processor turning said actuator off corresponding to said selected sprinkler unit in accordance with said commands received from said electronic device, said second transceiver communicating to said electronic device the relative humidity received from said moisture sensor corresponding to each of said sprinkler units.
